(19) United States
(12) Patent Application Publication
(10) Pub. No.: US 2025/0219164 A1
(43) Pub. Date: Jul. 3, 2025

(54) POSITIVE ELECTRODE PLATE AND SECONDARY BATTERY

(71) Applicant: Ningde Amperex Technology Limited, Ningde (CN)

(72) Inventor: Yali CHEN, Ningde (CN)

(73) Assignee: Ningde Amperex Technology Limited, Ningde (CN)

(21) Appl. No.: 19/003,116

(22) Filed: Dec. 27, 2024

(30) Foreign Application Priority Data
Dec. 29, 2023 (CN) 202311865909.9

(51) Int. Cl. H01M 10/42; H01M 4/02; H01M 4/131; H01M 4/136; H01M 10/0525

(52) U.S. Cl. CPC H01M 10/4235; H01M 4/131; H01M 4/136; H01M 10/0525; H01M 2004/021; H01M 2004/028

(57) ABSTRACT

A positive electrode plate includes a positive electrode current collector and a positive electrode active material layer. A safety coating is provided between the positive electrode current collector and the positive electrode active material layer, and the safety coating is disposed on a surface of the positive electrode current collector. The safety coating contains substance I, and the substance I is formed by dehydration of a first substance via a drying process of the positive electrode plate, where the first substance includes silica sol and/or alumina sol. The surface of the current collector of the positive electrode plate is provided with the safety coating, where the safety coating has good high-temperature resistance and can effectively protect the aluminum foil at high temperatures, thereby enhancing the thermal safety performance of the lithium-ion battery.

### CROSS REFERENCE TO RELATED APPLICATIONS

This application claims priority to the Chinese Patent Application Ser. No. 202311865909.9, filed on Dec. 29, 2023, the content of which is incorporated herein by reference in its entirety.

### TECHNICAL FIELD

This application relates to the field of battery technologies, in particular, to a positive electrode plate and a secondary battery.

### BACKGROUND

As the application range of lithium-ion batteries becomes increasingly extensive, higher requirements are being placed on their safety performance, especially thermal safety performance. When lithium-ion batteries are subjected to abnormal conditions such as squeezing, collision, or puncturing, they are prone to catching fire or exploding due to internal short circuits. Additionally, lithium-ion batteries generate a significant amount of heat during normal operation. As a key structure for improving battery safety performance, existing positive electrode safety coatings have poor high-temperature resistance. They tend to shed powder, deform, or even detach at high temperatures, failing to protect the aluminum foil. This may also affect the normal operation of lithium-ion batteries, posing safety risks.

### SUMMARY

In view of this, this application provides a positive electrode plate and a secondary battery. A surface of a current collector of the positive electrode plate is provided with a safety coating, where the safety coating has good high-temperature resistance and can effectively protect the aluminum foil under high-temperature conditions, thereby enhancing the thermal safety performance of the lithium-ion battery.

According to a first aspect, this application provides a positive electrode plate. The positive electrode plate includes a positive electrode current collector and a positive electrode active material layer. A safety coating is provided between the positive electrode current collector and the positive electrode active material layer, and the safety coating is disposed on a surface of the positive electrode current collector. The safety coating contains substance I, and the substance I is formed by dehydration of a first substance via a drying process of the positive electrode plate, where the first substance includes silica sol and/or alumina sol. During the drying process, the first substance dehydrates to form a specific siloxane network structure and/or dehydrates and condenses to form a -O-Al-O- three-dimensional network structure. These structures can withstand high temperatures up to 1600° C. When the battery experiences an internal short circuit that generates high temperatures or releases a significant amount of heat during operation, substance I in the safety coating can protect the positive electrode current collector, preventing direct contact between the positive electrode current collector and the negative electrode, which could otherwise lead to cell fires or even explosions.

In some embodiments, based on a mass of the safety coating, the substance I has a mass percentage W₁ satisfying: 10 wt %<W₁≤30 wt %. Preferably, W₁ satisfies: 15 wt %≤W₁≤30 wt %.

In some embodiments, when heated at 120° C. for 60 s, the safety coating has a weight loss rate less than or equal to 0.5%.

In some embodiments, the safety coating further contains a binder. When the binder is used in combination with substance I, it contributes to synergistically enhancing the adhesion effect between the safety coating and the current collector, significantly improving the adhesion between the safety coating and the current collector. Particularly, when the battery experiences high temperatures due to an internal short circuit, the safety coating will not detach from the positive electrode current collector, significantly reducing a probability of peeling of the safety coating.

In some embodiments, based on the mass of the safety coating, the binder has a mass percentage W₂ satisfying: 2 wt %≤W₂≤10 wt %. Preferably, W₂ satisfies: 2 wt %≤W₂≤5 wt %.

In some embodiments, W₁/W₂ satisfies: 1<W₁/W₂<15. Preferably, W₁/W₂ satisfies: 3≤W₁/W₂≤8.

When the percentages of substance I and the binder are within the above range, it can significantly enhance the heat resistance of the safety coating on one hand, and improve the adhesion between the safety coating and the current collector at high temperatures on the other hand. This ensures that the safety coating will not detach when the battery generates a significant amount of heat during normal operation or experiences high temperatures due to an internal short circuit. Consequently, this effectively prevents direct contact between the positive electrode current collector and the negative electrode, thereby enhancing the thermal safety performance of the lithium-ion battery.

In some embodiments, substance I has an average particle size of 5 nm to 30 nm. Preferably, the substance I has an average particle size of 10 nm to 20 nm.

In some embodiments, the first substance has a solid content of 25% to 35%. Preferably, the first substance has a solid content of 28% to 32%.

In some embodiments, the first substance includes silica sol, with a solid content (that is, a mass percentage of SiO₂ in the silica sol) of 25% to 35%. Preferably, the silica sol has a solid content of 28% to 32%.

In some embodiments, the first substance includes alumina sol, with a solid content (that is, a mass content of Al₂O₃·H₂O in the alumina sol) of 25% to 35%. Preferably, the silica sol has a solid content of 28% to 32%.

The average particle size of substance I is appropriate and its solid content is within a suitable range. A high-density siloxane network structure is obtained after the first substance is dehydrated through drying. This structure is more conducive to protecting the aluminum foil at high temperatures, thereby reducing the risk of an internal short circuit.

In some embodiments, the binder is selected from polyacrylic acid and/or sodium carboxymethyl cellulose binder. The polyacrylic acid has a number-average molecular weight of 3000 to 500000. Preferably, the polyacrylic acid has a number-average molecular weight of 5000 to 200000. The sodium carboxymethyl cellulose binder has a viscosity of 1000 mPa·s to 5000 mPa·s. Preferably, the sodium carboxymethyl cellulose binder has a viscosity of 1500 mPa·s to 3500 mPa·s. At this time, an appropriate binder is conducive to synergizing with substance I, thereby enhancing the adhesion between the safety coating and the current collector, especially reducing a risk of powder shedding and peeling of the safety coating at high temperatures, and improving the thermal safety performance of the battery.

In some embodiments, the safety coating further contains inorganic particles, where the inorganic particles are selected from at least one of boehmite, zinc borate, barium borate, aluminum oxide, antimony oxide, aluminum hydroxide, or magnesium hydroxide. These types of inorganic particles help to improve the thermal stability of the safety coating.

In some embodiments, Dv50 of the inorganic particles is 0.1 μm to 2 μm. Preferably, Dv50 of the inorganic particles is 0.7 μm to 1.5 μm. Dv90 of the inorganic particles is greater than 2 μm and less than or equal to 3 μm.

In some embodiments, based on the mass of the safety coating, the inorganic particles have a mass percentage W₃ satisfying:(1−W₁−W₂−W₃)≤0.1.

In some embodiments, the safety coating has a porosity of 25% to 40%, and the safety coating has a thickness of 0.8 μm to 20 μm.

Inorganic particles with the above particle size range and percentage are more conducive to interacting with substance I and the binder, enhancing the thermal stability of the safety coating. When the thickness of the safety coating is appropriate, and the proportions of the three are suitable, it helps to achieve an appropriate range of porosity for the safety coating. This can effectively reduce the risk of a short circuit caused by burrs and particles. Moreover, the particle size of substance I is at a nanometer scale and has a large proportion, increasing the overall quantity of small-size particles in the electrode plate, thereby improving the ability of the electrode plate to absorb the electrolyte solution, and improving the electrical performance.

In some embodiments, the positive electrode current collector includes a first region provided with tabs, a second region provided with the positive electrode active material layer, and an uncoated foil zone, where the second region and the uncoated foil zone are provided with the safety coating. The positive electrode current collector is provided with the safety coating in both the second region and the uncoated foil zone, greatly improving the safety performance of the lithium-ion battery when subjected to abnormal conditions such as squeezing, collision, or puncturing.

In some embodiments, when the safety coating and the positive electrode active material layer are collectively referred to as a membrane layer, the membrane layer has a membrane resistance of 1Ω to 8Ω. Preferably, the membrane layer has a membrane resistance of 4Ω to 6Ω. After the membrane layer is roasted at 600° C. for 2 h, the membrane layer has a membrane resistance greater than or equal to 0.8Ω. Preferably, after the membrane layer is roasted at 600° C. for 2 h, the membrane layer has a membrane resistance of 3Ω to 8Ω. It can be seen that after high temperatures, the safety coating does not peel off, preventing a sudden drop in the resistance of the current collector that could lead to a large short-circuit current, ensuring that the battery does not catch fire. If the resistance is too low, the short-circuit current will be great, increasing the safety risk. However, if the resistance is too high, it will affect the electrical performance. Therefore, the membrane resistance needs to be within an appropriate range.

In some embodiments, the safety coating and the current collector have an adhesion force inbetween greater than or equal to 200 N/m. Preferably, the safety coating and the current collector have an adhesion force inbetween of 305 N/m to 345 N/m. After being roasted at 600° C. for 2 h, the safety coating and the current collector have an adhesion force in between greater than or equal to 10 N/m. Preferably, after being roasted at 600° C. for 2 h, the safety coating and the current collector have an adhesion force inbetween of 35 N/m to 45 N/m. It can be seen that after high temperatures, the safety coating does not peel off and still protects the current collector.

In some embodiments, after being roasted at 600° C. for 2 h, the safety coating has a powder dropping rate less than or equal to 8%. It can be seen that after high temperatures, the safety coating does not peel off and still protects the current collector.

According to a second aspect, this application provides a secondary battery. The secondary battery includes the above positive electrode plate.

### DETAILED DESCRIPTION

To make the objectives, technical solutions, and advantages of this application more comprehensible, the following describes this application in detail with reference to embodiments. It should be understood that the specific embodiments described herein are merely used to explain this application but are not intended to limit this application.

### Safety Coating

The safety coating is disposed between the current collector and the positive electrode active material layer and covers the entire current collector, to protect the positive electrode current collector from coming into contact with the negative electrode in any situation, thereby avoiding fire and explosion caused by an internal short circuit. The safety coating contains substance I, and the substance I is formed by dehydration of a first substance via a drying process, where the first substance includes silica sol and/or alumina sol.

In some embodiments, the first substance includes silica sol (SiO₂·H₂O).

In some embodiments, the first substance includes alumina sol (a(Al₂O₃·H₂O)cHₓ·dH₂O, where Hₓ is a gel solvent).

In some embodiments, the substance I has an average particle size of 5 nm to 30 nm.

Exemplarily, the substance I has an average particle size of 5 nm, 6 nm, 8 nm, 10 nm, 12 nm, 13 nm, 15 nm, 18 nm, 20 nm, 25 nm, 30 nm, or in a range defined by any two of the above values.

In some embodiments, the first substance has a solid content of 25% to 35%.

Exemplarily, the first substance has a solid content of 25%, 28%, 30%, 32%, 35%, or in a range defined by any two of the above values.

In some embodiments, the safety coating includes a binder, where the binder is selected from polyacrylic acid and/or sodium carboxymethyl cellulose binder. The polyacrylic acid has a number-average molecular weight of 3000 to 500000. The sodium carboxymethyl cellulose binder has a viscosity of 1000 mPa·s to 5000 mPa·s.

Exemplarily, the polyacrylic acid has a number-average molecular weight of 3000, 5000, 8000, 20000, 50000, 100000, 150000, 200000, 300000, 400000, 500000, or in a range defined by any two of the above values.

Exemplarily, the sodium carboxymethyl cellulose binder has a viscosity of 1000 mPa·s, 1500 mPa·s, 2000 mPa·s, 2500 mPa·s, 3000 mPa·s, 3500 mPa·s, 4000 mPa·s, 4500 mPa·s, 5000 mPa·s, or in a range defined by any two of the above values.

In some embodiments, based on a mass of the safety coating, the substance I has a mass percentage W₁ satisfying 10 wt %<W_{1≤}30 wt %.

Exemplarily, the first substance has a mass percentage of 10.5 wt %, 13 wt %, 15 wt %, 18 wt %, 20 wt %, 25 wt %, 30 wt %, or in a range defined by any two of the above values.

In some embodiments, when heated at 120° C. for 60 s, the safety coating has a weight loss rate less than or equal to 0.5%. Exemplarily, the safety coating has a weight loss rate of 0.0001%, 0.001%, 0.1%, 0.2%, 0.3%, 0.4%, 0.5%, or in a range defined by any two of the above values.

In some embodiments, based on the mass of the safety coating, the binder has a mass percentage W₂ satisfying: 2 wt %≤W₂≤10 wt %.

Exemplarily, the binder has a mass percentage of 2 wt %, 2.5 wt %, 3 wt %, 5 wt %, 6 wt %, 8 wt %, 10 wt %, or in a range defined by any two of the above values.

In some embodiments, W₁/W₂ satisfies: 1<W₁/W₂<15. Exemplarily, W₁/W₂ is 1.5, 3, 4, 5, 7, 8, 10, 12, 14, 14.5, 14.8, or in a range defined by any two of the above values.

In some embodiments, the safety coating further contains inorganic particles, where the inorganic particles are selected from at least one of boehmite, zinc borate, barium borate, aluminum oxide, antimony oxide, aluminum hydroxide, or magnesium hydroxide. Dv50 particle size of the inorganic particles is 0.1 μm to 2 μm, and Dv90 particle size of the inorganic particles is greater than 2 μm and less than or equal to 3 μm.

Exemplarily, Dv50 of the inorganic particles is 0.1 μm, 0.3 μm, 0.5 μm, 0.7 μm, 1 μm, 1.3 μm, 1.5 μm, 1.7 μm, 2 μm, or in a range defined by any two of the above values.

Exemplarily, Dv90 of the inorganic particles is 2.1 μm, 2.3 μm, 2.5 μm, 2.8 μm, 3 μm, or in a range defined by any two of the above values.

In some embodiments, based on the mass of the safety coating, the inorganic particles have a mass percentage W₃ satisfying:(1−W₁−W₂−W₃)≤0.1. Exemplarily, the value of (1−W₁−W₂−W₃) is 0, 0.005, 0.008, 0.001, 0.05, 0.08, 0.1, or in a range defined by any two of the above values.

In some embodiments, when the safety coating and the positive electrode active material layer are collectively referred to as a membrane layer, the membrane layer has a membrane resistance of 1Ω to 8Ω.

Exemplarily, the membrane layer has a membrane resistance of 1 Ω, 2 Ω, 4 Ω, 6 Ω, 8Ω, or in a range defined by any two of the above values.

In some embodiments, after being roasted at 600° C. for 2 h, the membrane layer has a membrane resistance greater than or equal to 0.8Ω.

Exemplarily, after being roasted at 600° C. for 2 h, the membrane layer has a membrane resistance of 0.8 Ω, 1 Ω, 1.5 Ω, 2 Ω, 3 Ω, 5 Ω, 6 Ω, 8Ω, or in a range defined by any two of the above values.

In some embodiments, the safety coating and the current collector have an adhesion force inbetween greater than or equal to 200 N/m.

Exemplarily, the safety coating and the current collector have an adhesion force inbetween of 200 N/m, 220 N/m, 250 N/m, 280 N/m, 305 N/m, 320 N/m, 345 N/m, or in a range defined by any two of the above values.

In some embodiments, after being roasted at 600° C. for 2 h, the safety coating and the current collector have an adhesion force inbetween greater than or equal to 10 N/m. Exemplarily, after being roasted at 600° C. for 2 h, the safety coating and the current collector have an adhesion force inbetween of 10 N/m, 15 N/m, 20 N/m, 30 N/m, 35 N/m, 40 N/m, 45 N/m, or in a range defined by any two of the above values.

In some embodiments, the safety coating has a porosity of 25% to 40%, and the safety coating has a thickness of 0.8 μm to 20 μm.

Exemplarily, the safety coating has a porosity of 25%, 30%, 35%, 40%, or in a range defined by any two of the above values.

Exemplarily, the safety coating has a thickness of 0.8 μm, 2 μm, 4 μm, 8 μm, 10 μm, 15 μm, 18 μm, 20 μm, or in a range defined by any two of the above values.

In some embodiments, after being roasted at 600° C. for 2 h, the safety coating has a powder dropping rate less than or equal to 8%.

Method for preparing the safety coating:
mixing the first substance, binder, inorganic particles, and solvent, and stirring the obtained mixture to uniformity to obtain a coating slurry;
coating the coating slurry onto the current collector to obtain a current collector with safety coating I, referred to as current collector I; and
drying the current collector I to obtain a current collector coated with the safety coating, which is the current collector of this application.

For example, add the first substance, binder, and inorganic particles to deionized water at a mass ratio of (5%-15%):(2%-8%):(77%-93%), stir the obtained mixture at a stirring speed of 1000 rpm to 1800 rpm for 1.5 h to 2.5 h to obtain a coating slurry.

### Secondary Battery

The secondary battery includes a positive electrode plate, a negative electrode plate, a separator, and an electrolyte solution, where the separator is disposed between the positive electrode plate and the negative electrode plate.

### Positive Electrode Plate

The positive electrode plate includes a positive electrode current collector and a positive electrode active material layer, where a surface of the positive electrode current collector facing the positive electrode active material layer is provided with a safety coating.

The positive electrode active material in the positive electrode active material layer may be selected from one or more of a lithium cobalt oxide, a lithium nickel oxide, a lithium manganese oxide, a lithium nickel manganese oxide, a lithium nickel cobalt manganese oxide, a lithium nickel cobalt aluminum oxide, a lithium iron phosphate, and a compound obtained by adding other transition metals or non-transition metals to the above compounds.

Exemplarily, the positive electrode current collector may be made of a material such as metal foil or a porous metal plate, for example, foil or a porous plate made of aluminum, copper, nickel, titanium, iron, or their alloys, such as aluminum (Al) foil.

Method for preparing positive electrode plate:
obtaining the current collector with the safety coating prepared as described above; dispersing the positive electrode active material, the positive electrode binder, and the conductive agent in an NMP solution; stirring and mixing the obtained mixture to uniformity to obtain a positive electrode slurry with a solid content of 65 wt %-75 wt %, where a mass ratio of the positive electrode active material, the positive electrode binder, and the conductive agent in the solid components is (95-97):(1-3):(1-3); and coating the positive electrode slurry onto the safety coating of the current collector, and performing secondary drying, cold pressing, and other processes to obtain the positive electrode plate.

### Others

The negative electrode plate includes a negative electrode current collector and a negative electrode active layer disposed on a surface of the negative electrode current collector, where the negative electrode active layer includes a negative electrode active material. The thickness of the negative electrode active layer is not particularly limited in this application, provided that the objectives of this application can be achieved. For example, the thickness of the negative electrode active layer is 30 μm to 120 μm. In some embodiments, the negative electrode active material may include at least one of a carbon material or a silicon-based material. In some embodiments, the carbon material includes but is not limited to at least one of natural graphite, artificial graphite, mesocarbon microbeads, hard carbon, or soft carbon. In some embodiments, the silicon-based material includes but is not limited to at least one of silicon, silicon-oxygen composite material, or silicon-carbon composite material. The negative electrode current collector is not particularly limited in this application, provided that the objectives of this application can be achieved. For example, it may include copper foil, copper alloy foil, nickel foil, stainless steel foil, titanium foil, foamed nickel, foamed copper, a composite current collector (for example, a composite current collector with a metal layer disposed on a surface of the polymer layer), or the like. The thickness of the negative electrode current collector is not particularly limited in this application, provided that the objectives of this application can be achieved. For example, the thickness of the negative electrode current collector is 5 μm to 12 μm. The negative electrode active layer may further include a binder and a thickener. The types of the binder and the thickener are not particularly limited in this application, provided that the objectives of this application can be achieved. For example, the binder may include but is not limited to at least one of polyvinyl alcohol, polyvinyl chloride, carboxylated polyvinyl chloride, polyvinyl fluoride, polyvinyl pyrrolidone, polyurethane, polytetrafluoroethylene, polyvinylidene fluoride, styrene butadiene rubber, or acrylated styrene butadiene rubber; and the thickener may include but is not limited to at least one of sodium carboxymethyl cellulose or lithium carboxymethyl cellulose. The negative electrode active layer may further include a conductive agent. The type of the conductive agent is not particularly limited in this application, provided that the objectives of this application can be achieved. For example, the conductive agent may include but is not limited to at least one of conductive carbon black, carbon nanotubes (CNTs), carbon fiber, Ketjen black, graphene, a metal material, or a conductive polymer. The mass ratio of the negative electrode active material, conductive agent, binder, and thickener in the negative electrode active layer is not particularly limited in this application. Persons skilled in the art can make a selection based on actual needs, provided that the objectives of this application can be achieved. Optionally, the negative electrode plate may further include a conductive layer and the conductive layer is sandwiched between the negative electrode current collector and the negative electrode active layer. The composition of the conductive layer is not particularly limited in this application, and it may be a commonly used conductive layer in the field. For example, the conductive layer includes a conductive agent and a binder. The conductive agent and the binder in the conductive layer are not particularly limited in this application. For example, they may be at least one of the conductive agent and binder in the negative electrode active layer mentioned above.

The separator may include a substrate layer and a surface treatment layer. The substrate layer may be a non-woven fabric, film, or composite film having a porous structure, and a material of the substrate layer may include at least one of polyethylene, polypropylene, polyethylene glycol terephthalate, or polyimide. Optionally, at least one surface of the substrate layer is provided with a surface treatment layer, where the surface treatment layer may be a binding layer or a heat-resistant layer. For example, the binding layer contains a binder, and a material of the binder includes at least one of polyamide, polyacrylonitrile, acrylate polymer, polyacrylic acid, polyacrylate, polyvinylpyrrolidone, polyvinyl ether, or polyvinylidene fluoride or vinylidene fluoride-hexafluoropropylene copolymer. The heat-resistant layer includes inorganic particles and a binder. The inorganic particles are not particularly limited, for example, the inorganic particles may include at least one of aluminum oxide, silicon oxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited, for example, the binder may be at least one of the binders in the foregoing binding layer.

The electrolyte solution includes an organic solvent and a lithium salt; where the organic solvent includes a carbonate solvent, a carboxylate solvent, or a combination thereof, where the carbonate solvent includes at least one of diethyl carbonate (DEC), dimethyl carbonate (DMC), dipropyl carbonate (DPC), methylpropyl carbonate (MPC), ethylpropyl carbonate (EPC), ethylmethyl carbonate (MEC), ethylene carbonate (EC), propylene carbonate (PC), or butylene carbonate (BC) The carboxylate solvent includes at least one of ethyl formate, methyl acetate, ethyl acetate, propyl acetate, methyl propionate, ethyl propionate, propyl propionate, butyl butyrate, ethyl difluoroacetate, difluoroethyl acetate, ethyl trifluoroacetate, trifluoroethyl acetate, or methyl trifluoropropionate. The lithium salt includes at least one of lithium hexafluorophosphate (LiPF₆), lithium bis(oxalatoborate) (LiB(C₂O₄)₂, LiBOB), lithium difluorooxalatoborate (LiBF₂(C₂O₄), LiDFOB), lithium tetrafluoroborate (LiBF₄), lithium bis(fluorosulfonyl)imide (LiFSI), or lithium bis(trifluoromethanesulfonyl)imide (LiTFSI).

The above electrolyte solution may further include an electrolyte solution additive, where the electrolyte solution additive may include but is not limited to at least one of fluoroethylene carbonate (FEC), vinyl ethylene carbonate (VC), or 1,3-propane sultone (PS).

Specifically, the secondary battery of this application is a lithium secondary battery, including a lithium metal secondary battery, a lithium-ion secondary battery, a lithium polymer secondary battery, or a lithium-ion polymer secondary battery.

The following describes the embodiments of this application more specifically by using examples and comparative examples. Unless otherwise stated, the parts, percentages, and ratios are all listed based on mass.

### Example 1

### I. Preparation of Lithium-Ion Battery

### Preparation of Safety Coating

4.95 kg of silica sol (first substance, with a solid content of SiO₂ is 30%), 0.5 kg of polyacrylic acid (binder), and 8 kg of boehmite (inorganic particles) were added to 15 L of deionized water. The mixture was stirred at a stirring speed of 1500 rpm for 2 h to obtain a coating slurry. The coating slurry was then applied onto aluminum foil to obtain aluminum foil with a safety coating I, referred to as current collector I. The current collector I was dried at 85° C. to obtain a current collector coated with the safety coating on a single side. The same steps were then repeated on another surface of the aluminum foil to obtain a current collector coated with the safety coating on two sides.

The silica sol had an average particle size of 15 nm and a solid content of 10%. The polyacrylic acid had a number-average molecular weight of 20000. Dv50 of the boehmite was 1.0 μm, and Dv90 of the boehmite was 2.5 μm.

The difference between Example 2 and Example 1 is that in Example 2, the first substance used was alumina sol, while all other conditions were the same as in Example 1.

The difference between Example 3, Example 4, and Example 9 and Example 1 is that in Example 3, Example 4, and Example 9, the percentage of the first substance was adjusted, while all other conditions were the same as in Example 1.

The difference between Example 5 and Example 1 is that in Example 5, the binder used was sodium carboxymethyl cellulose binder, with a concentration of sodium carboxymethyl cellulose in the sodium carboxymethyl cellulose binder being 1%, and the viscosity of the sodium carboxymethyl cellulose binder being 2000 mPa·s.

The difference between Example 6, Example 7, and Example 10 and Example 1 is that in Example 6, Example 7, and Example 10, the percentage of the binder was adjusted, while all other conditions were the same as in Example 1.

### Preparation of Positive Electrode Plate

The positive electrode active material, lithium nickel cobalt manganese oxide (LiNi_{0.8}Co_{0.1}Mn_{0.1}O₂), the positive electrode binder polyvinylidene fluoride (PVDF), and the conductive agent Super-P were mixed to uniformity in N-methyl-2-pyrrolidone (NMP) at a mass ratio of 96:2:2 to obtain a positive electrode slurry. The positive electrode slurry was uniformly coated onto the current collector safety coating with a thickness of 12 μm and dried at 120° C. to obtain a positive electrode plate with a positive electrode active material layer coated on one side. The same steps were repeated on the safety coating on another surface of the aluminum foil to obtain a positive electrode plate with positive electrode active material layers coated on two sides. The positive electrode plate was then compacted and cut to obtain a positive electrode plate.

### Preparation of Negative Electrode Plate

The negative electrode active material graphite, the thickener sodium carboxymethyl cellulose (CMC), and the binder styrene-butadiene rubber (SBR) were mixed to uniformity in water at a mass ratio of 97.4:1.2:1.4 to obtain a negative electrode slurry. The negative electrode slurry was uniformly coated onto the negative electrode current collector copper foil with a thickness of 12 μm, and dried at 120° C. to obtain a negative electrode plate with a negative electrode active material layer coated on a single side. The same steps were repeated on another side of the copper foil to obtain a negative electrode plate with negative electrode active material layers coated on two sides. The negative electrode plate was then compacted and cut to obtain a negative electrode plate.

### Preparation of Electrolyte Solution

In an argon atmosphere glove box with a moisture content of <10 ppm, ethylene carbonate, propylene carbonate, and dimethyl carbonate with a saturated vapor pressure of 4 KPa-100 KPa at 25° C. were mixed to uniformity at a mass ratio of 10:10:80. Fully dried lithium salt LiPF₆ was then dissolved in the above non-aqueous solvent to obtain an electrolyte solution. Based on a mass of the electrolyte solution, a mass percentage of the lithium salt LiPF₆ was 12.5%.

### Preparation of Lithium-Ion Battery

A 10 μm polypropylene porous film was used as the separator. The prepared positive electrode plate, separator, and negative electrode plate were sequentially stacked and then wound to obtain an electrode assembly. After tabs were welded, the electrode assembly was placed into an aluminum-plastic film, and dried in a vacuum oven at 80° C. for 12 hours to remove water. The prepared electrolyte solution was injected, and vacuum packaging, standing, formation (charged to 3.5V at a constant current of 0.02C, and charged to 3.9V at a constant current of 0.1C), capacity test, shaping, and other processes were performed to obtain a lithium-ion battery.

### II. Tests

### 2.1 Porosity Test

(1) Sample pre-treatment: A fully discharged cell was disassembled, and an electrode plate was soaked in NMP and ultrasonicated for 10 min to remove the upper active material. The remaining base-coated electrode plate was punched into circular discs more than 40 pieces with a diameter of 10 mm or 14 mm, ensuring that the discs have flat surfaces and no notches. The samples were weighed and their thicknesses were measured. (2) Testing procedure: \textcircled{1} A valve inside the instrument was opened to ventilate the interior of the instrument, preventing excessive internal pressure. \textcircled{2} A compressed gas cylinder was unscrewed, and a pressure valve was adjusted to balance the pressure between 0.14 MPa-0.18 MPa. The valve was then closed, and SAVE was clicked to save the settings. \textcircled{3} The instrument cover was unscrewed, the sample cup was taken out, and the sample cup was tilted. The sample balls were slowly slid into the sample cup, which was then placed back into the sample chamber, and the instrument cover was tightened. \textcircled{4} CHOICE was clicked to select the volume of the sample cup used, and then the ENTER key was pressed to start the test. \textcircled{5} Once the test was completed, the instrument returned to the Reload state. The CLEAR key was clicked to view the average volume, which was recorded. The volume deviation of the sample balls was calculated using the formula:sample ball volume ±(sample cup volume *0.0003+sample ball volume *0.0003). If the test results were all within a range, the instrument was deemed stable and ready for testing; otherwise, calibration was needed. \textcircled{6} 30-40 pieces of relatively flat and intact electrode plate discs were selected and placed into the sample cup, and the number of samples loaded was recorded. The sample cup was placed into the sample chamber and the cover was tightened. The ATL key was pressed, the CHOICE key was clicked to select a 1 cm³ sample cup, and then the ENTER key was pressed to start the test. When the instrument returned to the Reload state, the CLEAR key was pressed to obtain an average value of the test results.

### 2.2. Adhesion Force Test

(1) A fully discharged cell was disassembled, and a safety current collector (that is, a current collector with a safety coating) not coated with an active layer was obtained. Alternatively, an electrode plate was placed in a beaker with NMP, and the beaker was placed in an ultrasonic bath at 50 Hz for 10 min to remove the surface active layer. (2) The electrolyte solution or NMP on the surface of the electrode plate was washed away using DMC. (3) Dust-free paper was used to absorb the surface DMC, and the electrode plate was dried in a fume hood. (4) The dried safety current collector was placed in a muffle furnace at 600° C. for 2 h. (5) The dried safety current collector was cut into test samples using a blade, ensuring the sample width matched the width of the double-sided tape and the length was ≥20 mm. (6) Specialized double-sided tape was adhered to a steel plate, with the tape width matching the sample width and the tape length being shorter than the sample length. (7) The test sample prepared in step (5) was adhered to the double-sided tape, with the testing surface facing down. (8) A paper strip, with a width matching the electrode plate and a length 80 mm-200 mm longer than the sample length, was inserted under the electrode plate and fixed with crepe tape. (9) The power of a Sunstest tensile machine was turned on, the indicator light illuminated, and the limit block was adjusted to an appropriate position. (10) The sample prepared in step (7) was fixed on the testing platform, the speed was set to 10 mm/min, and the test was started by pulling the paper strip at a 90° angle until the test was completed. (11) The test data were saved according to the software prompts. After the test was completed, the electrode plate was taken out, and the instrument was turned off.

### 2.3 Powder Dropping Rate Test

(1) A fully discharged cell was disassembled, and a safety current collector not coated with an active layer was obtained. Alternatively, the electrode plate was placed in a beaker with NMP, and the beaker was placed in an ultrasonic bath at 50 Hz for 10 min to remove the surface active layer. (2) The electrolyte solution or NMP on the surface of the electrode plate was washed away using DMC. (3) Dust-free paper was used to absorb the surface DMC, and the electrode plate was dried in a fume hood. (4) In an environment with humidity ≤75% at room temperature, the safety current collector was cut into test samples of 100 mm×200 mm. (5) The test sample was folded and rolled once with a 2 kg roller, with the total fold length recorded as D. The fold of the test sample was observed under an optical microscope, and the powder dropping length was measured and recorded as d. (6) The brittleness powder dropping rate=d/D*100%.

### 2.4 Safety Coating Component Percentage Test

A scanning electron microscope (SEM) in cooperation with an energy dispersive spectrometer (EDS) was used to test the percentages and distribution of elements in the positive electrode material layer of a cross-section of the base-coated electrode plate. The test steps were as follows: (1) A fully discharged cell was disassembled, and a safety current collector not coated with an active layer was obtained. Alternatively, the electrode plate was placed in a beaker with NMP, and the beaker was placed in an ultrasonic bath and ultrasonicated at 50 Hz for 10 min to remove the surface active layer, leaving only the base coating layer. (2) A magnification of 100× to 2000× was selected for the SEM, covering the main body of the positive electrode material layer within the field of view. (3) EDS distribution analysis was performed on the area within the field of view in the area scan mode, and specific elements were selected for distribution analysis. (4) The element percentage data were output, and the percentage of each element was confirmed. (5) Steps (1) to (4) were repeated three times to increase the number of parallel sample tests, and the average value was taken as the percentage of each element.

### 2.5 Membrane Resistance Test (Including Room Temperature and High Temperature)

(1) A fully discharged cell was disassembled, and a safety current collector not coated with an active layer was obtained. Alternatively, the electrode plate was placed in a beaker with NMP, and the beaker was placed in an ultrasonic bath and ultrasonicated at 50 Hz for 10 min to remove the surface active layer. (2) The electrolyte solution or NMP on the surface of the electrode plate was washed away using DMC and dried for 2 h. (3) The power cable of the resistance meter was connected, and stable compressed air was connected to a pressure regulator through a 10 mm tube. (4) The power switch was turned on, the control button was pressed, and after the pressure value stabilized, the zero button was pressed. (5) The protective door was opened, the sample stage was taken out, and the cut base-coated electrode plate (approximately 60×80 mm) was placed on the base. The cover plate was put on, and the electrode plate covered the test hole. (6) The sample stage with the electrode plate was placed into the test chamber, the sample stage was moved to clip the test hole to the lower terminal, and the protective door was closed. (7) The software for the electrode plate resistance meter was started. “Test Parameters” was clicked to enter the parameter setting interface, the single-point test mode was selected, and the “Start Experiment” button was clicked to perform the resistance test. (8) High-temperature resistance test: the base-coated electrode plate was placed in a muffle furnace at 600° C. for 2 h, then cooled to room temperature before performing the resistance test.

### 2.6 Nail Penetration Test Pass Rate for Cell

(1) Pre-penetration voltage&SOC: 4.5V/100% SOC. (2) In a test environment of 20° C.±5° C., the sample was placed on the test platform. A 3 mm diameter steel nail was used to penetrate the sample at a speed of 150 mm/s from the center position, completely piercing the sample. (3) Criteria for judgment:no fire, no explosion, and no smoke.

TABLE 1

| | | | | | | Membrane layer | | Safety current collector | | |
|---|---|---|---|---|---|---|---|---|---|---|
| | | | | | | | Membrane | | Adhesion | exposure |
| | | | | | | | resistance | | force after | to 600° C. |
| | Safety coating | | | | | | after | | exposure to | Powder |
| | | | | Substance | | | exposure to | Adhesion | 600° C. high | dropping of |
| | | Binder | First | I | W₁/ | Membrane | 600° C. high | force | temperature | the safety |
| | Binder | percentage | substance | percentage | W₂ | resistance | temperature | (N/m) | (N/m) | coating after |
| Example 1 | Polyacrylic | 5% | Silica sol | 15% | 3 | 4.50 | 4.00 | 336.4 | 38.1 | 3.5% |
| | acid | | | | | | | | | |
| Example 2 | Polyacrylic | 5% | Alumina sol | 15% | 3 | 4.40 | 2.50 | 300.5 | 24.5 | 3.6% |
| | acid | | | | | | | | | |
| Example 3 | Polyacrylic | 5% | Silica sol | 10% | 2 | 4.00 | 0.94 | 333.1 | 14.8 | 5.2% |
| | acid | | | | | | | | | |
| Example 4 | Polyacrylic | 5% | Silica sol | 30% | 6 | 5.95 | 8.00 | 202.6 | 43.2 | 1.2% |
| | acid | | | | | | | | | |
| Example 5 | Sodium | 5% | Silica sol | 15% | 3 | 4.50 | 3.50 | 281.9 | 36.6 | 3.5% |
| | carboxymethyl | | | | | | | | | |
| | cellulose | | | | | | | | | |
| | binder | | | | | | | | | |
| Example 6 | Polyacrylic | 2% | Silica sol | 15% | 7.5 | 4.55 | 4.75 | 211.4 | 35.6 | 3.6% |
| | acid | | | | | | | | | |
| Example 7 | Polyacrylic | 10% | Silica sol | 15% | 1.5 | 4.50 | 3.25 | 456.2 | 25.1 | 3.4% |
| | acid | | | | | | | | | |
| Example 8 | / | / | Silica sol | 35% | / | 6.35 | 8.50 | 52.4 | 50.4 | 0.5% |
| Example 9 | Polyacrylic | 5% | Silica sol | 3% | 0.6 | 3.00 | 0.15 | 270.3 | 8.2 | 10.0% |
| | acid | | | | | | | | | |
| Example 10 | Polyacrylic | 1% | Silica sol | 15% | 15 | 4.50 | 4.00 | 36.5 | 32.1 | 2.3% |
| | acid | | | | | | | | | |
| Comparative | Polyacrylic | 5% | — | — | — | 3.50 | 0.08 | 268.0 | 3.0 | 15.4% |
| example 1 | acid | | | | | | | | | |

Based on Table 1, the comparison between Example 1 to Example 10 and Comparative Example 1 shows that when substance I is not added to the safety coating, the membrane resistance of the positive electrode is relatively low under high-temperature conditions. At the same time, the adhesion force between the current collector and the safety coating is significantly lower compared to the case where the safety coating contains substance I, the safety coating experiences severe powder dropping, and the high-temperature safety of the battery is significantly affected. Example 1 and Example 2 represent cases where the first substance used is silica sol and alumina sol, respectively. That is, Example 1 and Example 2 differ only in the type of first substance, while all other conditions are the same. From the data in Table 1, it can be seen that the substance obtained from both silica sol and alumina sol, after drying and dehydration, can achieve high-temperature resistance. Particularly, when silica sol and/or alumina sol are appropriately combined with a binder, the adhesion force of the coated current collector at 600° C. high temperature is good, and the powder dropping rate is low. Example 3 to Example 5 investigate the percentage of the first substance. It can be seen that with an appropriate percentage of the first substance, the dehydrated substance I can better protect the aluminum foil. Example 6 to Example 7 investigate the percentage of the binder. It can be seen that when an appropriate amount of binder is used in combination with the first substance, it is more beneficial for the synergistic enhancement of the adhesion effect between the safety coating and the current collector. Comparing Example 7 and Example 8 with Comparative Example 1, it can be seen that when the safety coating contains both substance I and the binder, the positive electrode plate can have good adhesion performance and low membrane resistance at room temperature. Additionally, it maintains good adhesion performance and safety resistance under high-temperature conditions, allowing the battery to have both good electrochemical performance and excellent high-temperature safety performance.

In Table 2, inorganic particle parameters are further adjusted based on Example 4 in Table 1. For details, see Table 2.

TABLE 2

| | Safety coating | | | | | | | | |
|---|---|---|---|---|---|---|---|---|---|
| | | Average | | | Inorganic | Inorganic | | | Nail |
| | Substance I | particle size | Binder | | particle | particle | Safety coating | | penetration |
| | percentage | of substance I | percentage | Inorganic | Dv50 | Dv90 | Weight | | test pass |
| | W1 | (μm) | W2 | particle type | (μm) | (μm) | loss rate | Porosity | rate for cell |
| Example | 30% | 15 | 5% | Boehmite | 1 | 2.5 | 0.3% | 18 | 100% |
| 4 | | | | | | | | | |
| Example | 30% | 15 | 5% | Boehmite | 0.1 | 2.5 | 0.3% | 16 | 100% |
| 2-1 | | | | | | | | | |
| Examples | 30% | 15 | 5% | Boehmite | 2 | 2.5 | 0.3% | 25 | 80% |
| 2-2 | | | | | | | | | |
| Examples | 30% | 15 | 5% | Boehmite | 1 | 2 | 0.3% | 19 | 90% |
| 2-3 | | | | | | | | | |
| Example | 30% | 15 | 5% | Boehmite | 1 | 3 | 0.3% | 23 | 80% |
| 2-4 | | | | | | | | | |
| Example | 30% | 15 | 5% | Aluminum | 1 | 2.5 | 0.5% | 22 | 80% |
| 2-5 | | | | hydroxide | | | | | |
| Example | 30% | 15 | 5% | Magnesium | 1 | 2.5 | 0.4% | 22 | 80% |
| 2-6 | | | | hydroxide | | | | | |
| Example | 30% | 15 | 5% | Boehmite | 1 | 2.5 | 0.3% | 18 | 80% |
| 2-7 | | | | | | | | | |
| Example | 30% | 15 | 5% | Boehmite | 1 | 2.5 | 0.3% | 18 | 100% |
| 2-8 | | | | | | | | | |

Based on Table 2, it can be seen that further adjusting the parameters of the inorganic particles is more conducive to enhancing the thermal stability of the lithium-ion battery and can better prevent short-circuit risks caused by burrs and particles.

The foregoing descriptions are merely preferable embodiments of this application, but are not intended to limit this application. Any modification, equivalent replacement, or improvement made without departing from the spirit and principle of this application shall fall within the protection scope of this application.

What is claimed is:

1. A positive electrode plate, comprising a positive electrode current collector and a positive electrode active material layer;
a safety coating is provided between the positive electrode current collector and the positive electrode active material layer, and the safety coating is disposed on a surface of the positive electrode current collector; and
the safety coating contains substance I, and the substance I is formed by dehydration of a first substance via a drying process of the positive electrode plate, wherein the first substance comprises silica sol and/or alumina sol.

2. The positive electrode plate according to claim 1, wherein the positive electrode plate satisfies at least one of the following conditions:
(1) based on a mass of the safety coating, the substance I has a mass percentage W₁ and 10 wt %<W₁≤30 wt %; or
(2) when heated at 120° C. for 60 s, the safety coating has a weight loss rate less than or equal to 0.5%.

3. The positive electrode plate according to claim 2, wherein the safety coating further contains a binder; and
based on the mass of the safety coating, the binder has a mass percentage W₂ and 2 wt %≤W₂≤10 wt %.

4. The positive electrode plate according to claim 3, wherein 3≤W₁/W₂≤8.

5. The positive electrode plate according to claim 1, wherein an average particle size of the substance I is 5 nm to 30 nm.

6. The positive electrode plate according to claim 3, wherein the safety coating further contains inorganic particles, satisfying at least one of the following conditions:
(1) the inorganic particles are at least one of boehmite, zinc borate, barium borate, aluminum oxide, antimony oxide, aluminum hydroxide, or magnesium hydroxide;
(2) Dv50 of the inorganic particles is 0.1 μm to 2 μm, and Dv90 of the inorganic particles is greater than 2 μm and less than or equal to 3 μm; or
(3) based on the mass of the safety coating, the inorganic particles have a mass percentage W₃ and (1−W₁−W₂−W₃)≤0.1.

7. The positive electrode plate according to claim 1, wherein the positive electrode current collector comprises a first region provided with tabs, a second region provided with the positive electrode active material layer, and an uncoated foil zone, wherein the second region and the uncoated foil zone are provided with the safety coating.

8. The positive electrode plate according to claim 1, wherein the safety coating and the positive electrode active material layer are collectively referred to as a membrane layer, the membrane layer satisfies at least one of the following conditions:
(1) the membrane layer has a membrane resistance of 1Ω to 8Ω; or
(2) after being roasted at 600° C. for 2 h, the membrane layer has a membrane resistance greater than or equal to 0.8 Ω.

9. The positive electrode plate according to claim 1, satisfying at least one of the following conditions:
(1) an adhesion force between the safety coating and the positive electrode current collector is greater than or equal to 200 N/m; or
(2) after being roasted at 600° C. for 2 h, an adhesion force between the safety coating and the positive electrode current collector is greater than or equal to 10 N/m.

10. The positive electrode plate according to claim 1, satisfying at least one of the following conditions:
(1) the safety coating has a porosity of 25% to 40%, and the safety coating has a thickness of 0.8 μm to 20 μm; or
(2) after being roasted at 600° C. for 2 h, the safety coating has a powder dropping rate less than or equal to 8%.

11. A secondary battery, wherein the secondary battery comprises a positive electrode plate, wherein the positive electrode plate comprises a positive electrode current collector and a positive electrode active material layer;
a safety coating is provided between the positive electrode current collector and the positive electrode active material layer, and the safety coating is disposed on a surface of the positive electrode current collector; and
the safety coating contains substance I, and the substance I is formed by dehydration of a first substance via a drying process of the positive electrode plate, wherein the first substance comprises silica sol and/or alumina sol.

12. The second battery according to claim 11, wherein the positive electrode plate satisfies at least one of the following conditions:
(1) based on a mass of the safety coating, the substance I has a mass percentage W₁ and 10 wt %<W₁≤30 wt %; or
(2) when heated at 120° C. for 60 s, the safety coating has a weight loss rate less than or equal to 0.5%.

13. The second battery according to claim 12, wherein the safety coating further contains a binder; and
based on the mass of the safety coating, the binder has a mass percentage W₂ and 2 wt %≤W₂≤10 wt %.

14. The second battery according to claim 13, wherein 3≤W₁/W₂≤8.

15. The second battery according to claim 11, wherein an average particle size of the substance I is 5 nm to 30 nm.

16. The second battery according to claim 13, wherein the safety coating further contains inorganic particles, satisfying at least one of the following conditions:
(1) the inorganic particles are at least one of boehmite, zinc borate, barium borate, aluminum oxide, antimony oxide, aluminum hydroxide, or magnesium hydroxide;
(2) Dv50 of the inorganic particles is 0.1 μm to 2 μm, and Dv90 of the inorganic particles is greater than 2 μm and less than or equal to 3 μm; or
(3) based on the mass of the safety coating, the inorganic particles have a mass percentage W₃ and (1−W₁−W₂−W₃)≤0.1.

17. The second battery according to claim 11, wherein the positive electrode current collector comprises a first region provided with tabs, a second region provided with the positive electrode active material layer, and an uncoated foil zone, wherein the second region and the uncoated foil zone are provided with the safety coating.

18. The second battery according to claim 11, wherein the safety coating and the positive electrode active material layer are collectively referred to as a membrane layer, the membrane layer satisfies at least one of the following conditions:
(1) the membrane layer has a membrane resistance of 1Ω to 8Ω; or
(2) after being roasted at 600° C. for 2 h, the membrane layer has a membrane resistance greater than or equal to 0.8 Ω.

19. The second battery according to claim 11, satisfying at least one of the following conditions:
(1) an adhesion force between the safety coating and the positive electrode current collector is greater than or equal to 200 N/m; or
(2) after being roasted at 600° C. for 2 h, an adhesion force between the safety coating and the positive electrode current collector is greater than or equal to 10 N/m.

20. The second battery according to claim 11, satisfying at least one of the following conditions:
(1) the safety coating has a porosity of 25% to 40%, and the safety coating has a thickness of 0.8 μm to 20 μm; or
(2) after being roasted at 600° C. for 2 h, the safety coating has a powder dropping rate less than or equal to 8%.
